(19) United States
(12) Patent Application Publication
(10) Pub. No.: US 2026/0351847 A1
(43) Pub. Date: Nov. 5, 2026

(54) ANTENNA ELEMENT, ANTENNA ARRAY, ANTENNA APPARATUS, AND BASE STATION SYSTEM

(71) Applicant: HUAWEI TECHNOLOGIES CO., LTD., Shenzhen (CN)

(72) Inventors: Zijue Shan, Shenzhen (CN); Jinhui Li, Kunming (CN); Junjie Chao, Dongguan (CN); Jinju Wang, Dongguan (CN); Zhongwei Peng, Dongguan (CN); Lizhuo Wang, Shenzhen (CN)

(73) Assignee: HUAWEI TECHNOLOGIES CO., LTD., Shenzhen (CN)

(21) Appl. No.: 19/711,524

(22) Filed: Jun. 17, 2026

Related U.S. Application Data
(63) Continuation of application No. PCT/CN2024/137068, filed on Dec. 5, 2024.

(30) Foreign Application Priority Data
Dec. 19, 2023 (CN) 202323485868.9

(51) Int. Cl. H01Q 1/52; H01P 1/00; H01Q 1/24; H01Q 9/16; H01Q 19/10

(52) U.S. Cl. CPC H01Q 1/523; H01P 1/00; H01Q 1/246; H01Q 19/10; H01Q 9/16

(57) ABSTRACT

This application relates to an antenna element, an antenna array, an antenna apparatus, and a base station system. The antenna element can reduce dielectric loss of the feed network, suppress coupling between the feed network and the radiation arm, and improve radiation performance and isolation of the antenna element.

### CROSS-REFERENCE TO RELATED APPLICATIONS

This application is a continuation of International Application No. PCT/CN 2024/137068, filed on Dec. 5, 2024, which claims priority to Chinese Patent Application No. 202323485868.9, filed on Dec. 19, 2023. The disclosures of the aforementioned applications are hereby incorporated by reference in their entireties.

### TECHNICAL FIELD

This application relates to the field of communication technologies, and specifically, to an antenna element, an antenna array, an antenna apparatus, and a base station system.

### BACKGROUND

In recent years, mobile communication technologies have achieved great development. As an essential part of mobile communication, base station antennas have evolved alongside these technologies, progressing from single-frequency and dual-frequency base station antennas to multi-frequency and massive multiple-input multiple-output (Massive Multiple-Input Multiple-Output, Massive MIMO) base station antennas. Currently, as antenna arrays become increasingly complex, a quantity of antenna elements also increases. In existing antenna element structures, the feed network is coupled to the ground through a dielectric substrate, resulting in relatively high dielectric loss. In addition, the feed network is at a relatively short distance from a radiation arm, causing relatively strong coupling between the feed network and the radiation arm, which adversely affects antenna performance.

### SUMMARY

In view of this, this application provides an antenna element, an antenna array, an antenna apparatus, and a base station system, to address the problems that a feed network coupled to the ground through a dielectric substrate leads to relatively high dielectric loss, and that the close proximity of the feed network to the radiation arm causes relatively strong coupling between them, thereby affecting antenna performance.

A first aspect of embodiments of this application provides an antenna element, including an insulating substrate board, a feed network, a metal ground layer, a reflector plate, an insulating substrate arm, a radiation arm, and a feed balun. The feed network is connected to the insulating substrate board. The metal ground layer is connected to the insulating substrate board and disposed on a same side of the insulating substrate board as the feed network. At least a portion of the reflector plate is disposed on a side of the metal ground layer facing away from the insulating substrate board. The reflector plate is coupled to the metal ground layer and the feed network. The insulating substrate arm is connected to the insulating substrate board and disposed on a side of the insulating substrate board facing away from the feed network and the metal ground layer. The radiation arm is disposed on the insulating substrate arm. The feed balun is disposed on the insulating substrate arm. One end of the feed balun is electrically connected to the feed network, and the other end is electrically connected to the radiation arm to feed the radiation arm.

In this application, the reflector plate can focus radio frequency signals to a focal point of the radiation arm, thereby improving reception sensitivity of the radio frequency signals, and can block an interference wave outside the reflector plate. The metal ground layer is disposed on the same side of the insulating substrate board as the feed network, so that dielectric loss between the feed network and the reflector plate can be reduced, and radiation performance of the antenna element is improved. In addition, the metal ground layer in this structure occupies a relatively small area on the insulating substrate board, which makes it possible that the feed network and the metal ground layer are disposed on the same side of the insulating substrate board. Moreover, this structure saves cabling space of the feed network. In addition, as a main radiator of the antenna element, the radiation arm can effectively radiate or receive a radio frequency signal. The feed network and the radiation arm disposed on the insulating substrate arm are respectively disposed on two opposite sides of the insulating substrate board, so that coupling between the feed network and the radiation arm can be reduced, which effectively improves radiation performance and isolation of the antenna element.

In a possible design, the insulating substrate board includes a board body and a boss. The boss protrudes from the board body. The feed network is disposed on the board body. The metal ground layer is disposed on the boss. After the antenna element is assembled, it can be ensured that the metal ground layer disposed on the boss may be directly coupled to or coupled at an interval to the reflector plate.

In a possible design, the metal ground layer is directly coupled to the reflector plate. The antenna element of this structure is simple in structure and easy to fabricate.

In a possible design, the insulating substrate board further includes a support portion protruding from the board body toward the reflector plate. The support portion abuts against at least a part of the reflector plate. The metal ground layer and the reflector plate are spaced apart from each other.

It is unnecessary to use a screw or another structure for connecting the insulating substrate board with the reflector plate, which further reduces structural complexity of the antenna element, reduces difficulty in coupling between the metal ground layer and the reflector plate, and improves stability of the coupling between the metal ground layer and the reflector plate. In addition, this structure is simple, costs are low, and it can be ensured that a spacing distance between the metal ground layer and the reflector plate is stable, so that stability of the coupling between the metal ground layer and the reflector plate is improved to ensure radiation performance of the antenna element.

In a possible design, the insulating substrate arm includes a first plate and a second plate intersecting with each other. The first plate includes a first surface and a second surface that are disposed opposite to each other. The second plate includes a third surface and a fourth surface that are disposed opposite to each other. The radiation arm includes a first radiation arm, a second radiation arm, a third radiation arm, and a fourth radiation arm. The first radiation arm is disposed on the first surface. The second radiation arm is disposed on the second surface. The first radiation arm and the second radiation arm are respectively disposed on two sides of the second plate. The feed balun is configured to feed the first radiation arm and the second radiation arm to generate first polarization. The third radiation arm is disposed on the third surface. The fourth radiation arm is disposed on the fourth surface. The third radiation arm and the fourth radiation arm are respectively disposed on two sides of the first plate. The feed balun is configured to feed the third radiation arm and the fourth radiation arm to generate second polarization.

In this structure, two radiation arms of a same polarization are disposed on two opposite surfaces of a same plate in a staggered manner, so that the first radiation arm, the second radiation arm, the third radiation arm, and the fourth radiation arm are disposed on the first plate and the second plate more properly, which not only ensures radiation performance of the first radiation arm, the second radiation arm, the third radiation arm, and the fourth radiation arm, but also reduces space occupied by the first radiation arm, the second radiation arm, the third radiation arm, and the fourth radiation arm on the first plate and the second plate. Therefore, convenience is brought for disposing the feed balun on the first plate and the second plate flexibly, which not only improves a degree of design freedom of the antenna element, but also can reduce a size and disposing difficulty of the insulating substrate arm, thereby facilitating miniaturization design of the antenna element.

In a possible design, the first radiation arm is disposed on a side of the first surface close to the fourth surface. The second radiation arm is disposed on a side of the second surface close to the third surface. The third radiation arm is disposed on a side of the third surface close to the second surface. The fourth radiation arm is disposed on a side of the fourth surface close to the first surface.

The first radiation arm and the fourth radiation arm may be disposed on two adjacent surfaces, so that a third ground balun and a fourth ground balun may be disposed relatively close to each other. Therefore, the third ground balun and the fourth ground balun may be connected, through one same third plated through hole, to a metal ground layer disposed on the other side of the insulating substrate board. In addition, the second radiation arm and the third radiation arm may be disposed on two adjacent surfaces, so that a first ground balun and a second ground balun may be disposed relatively close to each other. Therefore, the first ground balun and the second ground balun may alternatively be connected, through one same third plated through hole, to a metal ground layer disposed on the other side of the insulating substrate board, thereby further reducing structural complexity of the antenna element, improving production efficiency, and reducing fabrication costs, which facilitates miniaturization and lightweight design of the antenna element.

In a possible design, the feed balun includes a first feed balun and a second feed balun. The first feed balun is disposed on the first surface, electrically connected to the first radiation arm, and coupled to the second radiation arm. The second feed balun is disposed on the fourth surface, electrically connected to the fourth radiation arm, and coupled to the third radiation arm.

The first feed balun is coupled to the first ground balun, so that the first feed balun can feed a current to the second radiation arm through the first ground balun, thereby meeting a feeding requirement of the second radiation arm. In addition, due to the first ground balun, it can be ensured that currents on the first radiation arm and the second radiation arm of the same polarization flow in consistent directions, thereby forming a dipole. This meets a design requirement of the antenna element. The second feed balun is coupled to the second ground balun, so that the second feed balun can feed a current to the third radiation arm through the second ground balun, thereby meeting a feeding requirement of the third radiation arm. In addition, due to the second ground balun, it can be ensured that currents on the third radiation arm and the fourth radiation arm of the same polarization flow in consistent directions, thereby forming a dipole. This meets a design requirement of the antenna element.

In a possible design, the second plate is provided with a first through hole, the first through hole is provided on a side of the second plate close to the first surface, and at least a portion of the first feed balun passes through the first through hole and is electrically connected to the first radiation arm. Additionally or alternatively, the first plate is provided with a second through hole, the second through hole is provided on a side of the first plate close to the fourth surface, and the second feed balun is electrically connected to the fourth radiation arm through the second through hole. In this structure, a feed balun is in direct connection with a radiation arm that is disposed on a same surface as the feed balun, so that it can be ensured that the connection between the feed balun and the radiation arm is stable.

In a possible design, the second plate is provided with a first plated through hole, the first plated through hole is provided on a side of the second plate close to the first surface, and at least a portion of the first feed balun extends to the second plate and is electrically connected to the first radiation arm through the first plated through hole. Additionally or alternatively, the first plate is provided with a second plated through hole, the second plated through hole is provided on a side of the first plate close to the fourth surface, and at least a portion of the second feed balun extends to the first plate and is electrically connected to the fourth radiation arm through the second plated through hole. In this structure, a feed balun is connected, through a plated through hole, to a radiation arm disposed on a same surface as the feed balun, so that design difficulty of the insulating substrate arm can be further reduced, thereby facilitating flexible connection of the feed balun to the radiation arm, and improving a degree of design freedom of the antenna element.

In a possible design, the antenna element further includes a first ground balun and a second ground balun. The first ground balun is disposed on the second surface and correspondingly coupled to the first feed balun. One end of the first ground balun is electrically connected to the second radiation arm, and the other end is electrically connected to the metal ground layer. The second ground balun is disposed on the third surface and correspondingly coupled to the second feed balun. One end of the second ground balun is electrically connected to the third radiation arm, and the other end is electrically connected to the metal ground layer.

The first feed balun is coupled to the first ground balun, so that the first feed balun can feed a current to the second radiation arm through the first ground balun, thereby meeting a feeding requirement of the second radiation arm. In addition, due to the first ground balun, it can be ensured that currents on the first radiation arm and the second radiation arm of the same polarization flow in consistent directions, thereby forming a dipole. This meets a design requirement of the antenna element. The second feed balun is coupled to the second ground balun, so that the second feed balun can feed a current to the third radiation arm through the second ground balun, thereby meeting a feeding requirement of the third radiation arm. In addition, due to the second ground balun, it can be ensured that currents on the third radiation arm and the fourth radiation arm of the same polarization flow in consistent directions, thereby forming a dipole. This meets a design requirement of the antenna element.

In a possible design, the antenna element further includes a third ground balun and a fourth ground balun. The third ground balun is disposed on the first surface. One end of the third ground balun is electrically connected to the first radiation arm, and the other end is electrically connected to the metal ground layer. The fourth ground balun is disposed on the fourth surface. One end of the fourth ground balun is electrically connected to the fourth radiation arm, and the other end is electrically connected to the metal ground layer.

When the first feed balun feeds the first radiation arm, the third ground balun may be equivalent to a short circuit of a ¼ wavelength, so that balanced feeding of the first radiation arm can be achieved, thereby ensuring that current amplitudes and phases on the first radiation arm and the second radiation arm of the same polarization are centrosymmetric, and improving radiation performance of the antenna element. When the second feed balun feeds the fourth radiation arm, the fourth ground balun may be equivalent to a short circuit of a ¼ wavelength, so that balanced feeding of the fourth radiation arm can be achieved, thereby ensuring that current amplitudes and phases on the third radiation arm and the fourth radiation arm of the same polarization are centrosymmetric, and improving radiation performance of the antenna element.

In a possible design, a plurality of metal ground layers are provided. Each metal ground layer is correspondingly electrically connected to at least one of the first ground balun, the second ground balun, the third ground balun, or the fourth ground balun, so that it can not only ensure reliable grounding of the ground balun, but also further reduce space occupied by the metal ground layer on the insulating substrate board, thereby facilitating flexible arrangement of the feed network in the antenna element, and improving a degree of design freedom of the antenna element.

In a possible design, one metal ground layer is provided. The first ground balun, the second ground balun, the third ground balun, and the fourth ground balun are electrically connected to the metal ground layer. In this way, structural complexity is further reduced, thereby facilitating manufacture and production, and reducing costs.

In a possible design, the insulating substrate board is provided with a third plated through hole. At least one of the first ground balun, the second ground balun, the third ground balun, or the fourth ground balun is electrically connected to the metal ground layer through the third plated through hole. This structure is simple and easy to implement, thereby further reducing fabrication costs.

In a possible design, the insulating substrate board is provided with a fourth plated through hole. The feed balun is electrically connected to the feed network through the fourth plated through hole. This structure is simple and easy to implement, thereby further reducing fabrication costs.

A second aspect of embodiments of this application provides an antenna array. The antenna array includes the antenna element according to any one of the foregoing embodiments. Because the antenna element has the foregoing technical effect, the antenna array including the antenna element should also have a corresponding technical effect. Details are not described herein again.

A third aspect of embodiments of this application provides an antenna apparatus. The antenna apparatus includes the antenna array according to any one of the foregoing embodiments. Because the antenna array has the foregoing technical effect, the antenna apparatus including the antenna array should also have a corresponding technical effect. Details are not described herein again.

A fourth aspect of embodiments of this application provides a base station system. The base station system includes the antenna apparatus according to any one of the foregoing embodiments. Because the antenna apparatus has the foregoing technical effect, the base station system including the antenna apparatus should also have a corresponding technical effect. Details are not described herein again.

It should be understood that the foregoing general descriptions and the following detailed descriptions are merely used as an example, and should not limit this application.

### BRIEF DESCRIPTION OF DRAWINGS

To describe technical solutions in embodiments of this application more clearly, the following briefly describes the accompanying drawings for embodiments. It is clear that the accompanying drawings in the following descriptions show merely some embodiments of this application, and a person of ordinary skill in the art may derive other drawings from these accompanying drawings without creative efforts.

FIG. 1 is a structural diagram of a base station system in some embodiments according to this application;

FIG. 2 is a structural diagram of the antenna apparatus in FIG. 1 in some embodiments;

FIG. 3 is a structural diagram of an antenna array in an embodiment according to this application;

FIG. 4 is a structural diagram of the antenna array in FIG. 3 from another perspective;

FIG. 5 is an exploded diagram of an antenna element according to a first embodiment of this application;

FIG. 6 is an exploded diagram of an antenna element according to a second embodiment of this application;

FIG. 7 is an exploded diagram of an antenna element according to a third embodiment of this application;

FIG. 8 is a structural diagram of an antenna element according to a first embodiment of this application;

FIG. 9 is a structural diagram of a partial structure of the antenna element in FIG. 8 from a first perspective;

FIG. 10 is a structural diagram of a partial structure of the antenna element in FIG. 8 from a second perspective;

FIG. 11 is a structural diagram of a partial structure of the antenna element in FIG. 8 from a third perspective;

FIG. 12 is a structural diagram of a partial structure of the antenna element in FIG. 8 from a fourth perspective;

FIG. 13 is a structural diagram of an antenna element according to a second embodiment of this application;

FIG. 14 is a structural diagram of a partial structure of the antenna element in FIG. 13 from a first perspective;

FIG. 15 is a structural diagram of a partial structure of the antenna element in FIG. 13 from a second perspective;

FIG. 16 is a structural diagram of a partial structure of the antenna element in FIG. 13 from a third perspective;

FIG. 17 is a structural diagram of a partial structure of the antenna element in FIG. 13 from a fourth perspective;

FIG. 18 is a diagram of a connection between a guiding layer and an insulating substrate arm according to a first embodiment of this application;

FIG. 19 is a diagram of a connection between a guiding layer and an insulating substrate arm according to a second embodiment of this application; and

FIG. 20 is a diagram of a connection between a guiding layer and an insulating substrate arm according to a third embodiment of this application.

### REFERENCE NUMERALS

100: antenna apparatus;
   101: antenna array;
   102: phase shifter;
   103: transmission network;
   104: combiner;
   105: radome;
200: antenna adjustment support;
300: fastening pole;
400: connector sealing member;
500: ground apparatus;
10: antenna element;
1: insulating substrate board;
   11: board body;
   12: boss;
   13: support portion;
2: insulating substrate arm;
   21: first plate;
      211: first surface;
      212: second surface;
   22: second plate;
      221: third surface;
      222: fourth surface;
   23: first through hole;
   24: first plated through hole;
   25: second plated through hole;
   26: third plated through hole;
   27: fourth plated through hole;
   28: protrusion;
3: feed network;
4: metal ground layer;
5: radiation arm;
   51: first radiation arm;
   52: second radiation arm;
   53: third radiation arm;
   54: fourth radiation arm;
6: feed balun;
   61: first feed balun;
   62: second feed balun;
71: first ground balun;
72: second ground balun;
73: third ground balun;
74: fourth ground balun;
8: reflector plate.
9: guiding layer;
   91: recess;
X: first direction;
Y: second direction;
Z: third direction.

The accompanying drawings herein are incorporated into this specification and constitute a part of this specification, show embodiments in accordance with this application, and are used, together with this specification, to explain the principle of this application.

### DESCRIPTION OF EMBODIMENTS

To better understand technical solutions of this application, the following describes embodiments of this application in detail with reference to the accompanying drawings.

In descriptions of this application, unless otherwise specified and limited, the terms “first” and “second” are merely intended for description, and shall not be understood as an indication or implication of relative importance. Unless otherwise specified or stated, the term “a plurality of” means two or more. The terms “connect”, “fasten”, and the like should be all understood in a broad sense. For example, “connect” may be a fixed connection, a detachable connection, an integral connection, or an electrical connection, or may be a direct connection or an indirect connection through an intermediate medium. A person of ordinary skill in the art may understand specific meanings of the foregoing terms in this application based on specific situations.

The terms used in embodiments of this application are merely for the purpose of illustrating specific embodiments, but are not intended to limit this application. The terms “a”, “said” and “the” of singular forms used in embodiments and the appended claims of this application are also intended to include plural forms, unless otherwise specified in the context clearly.

It should be understood that the term “and/or” used in this specification describes only an association relationship between associated objects and represents that three relationships may exist. For example, A and/or B may represent the following three cases: Only A exists, both A and B exist, and only B exists. In addition, the character “/” in this specification generally indicates an “or” relationship between the associated objects.

The following explains possible terms in embodiments of this application.

Coupling: may be understood as direct coupling and/or indirect coupling. A “coupling connection” may be understood as a direct coupling connection and/or an indirect coupling connection. The direct coupling may also be referred to as an “electrical connection”, which may be understood as physical contact and electrical conductivity of components; or may be understood as a form in which different components in a line structure are connected by using a physical line that can transmit an electrical signal, like printed circuit board (printed circuit board, PCB) copper foil or a conducting wire. The “indirect coupling” may be understood as electrical conductivity of two conductors through space or in a non-touch manner. In an embodiment, the indirect coupling may also be referred to as capacitive coupling. For example, signal transmission is implemented by forming an equivalent capacitor through coupling in a gap between two spaced conductive members.

Opposite/disposed opposite to each other: That A is disposed opposite to B may indicate that A and B are disposed opposite to each other or face to face (opposite to, or face to face).

Radiation arm: The radiation arm is an apparatus in an antenna, configured to receive/transmit an electromagnetic wave and radiate the electromagnetic wave. In some cases, an “antenna” is a radiator in a narrow sense. The radiator converts guided wave energy from a transmitter into a radio wave, or converts a radio wave into guided wave energy to radiate and receive the radio wave. Modulated high-frequency current energy (or guided wave energy) generated by the transmitter is transmitted to a transmit radiator through a feeder. The radiator converts the energy into specific polarized electromagnetic wave energy and radiates the energy in a required direction. A receive radiator converts specific polarized electromagnetic wave energy from a specific direction of space into modulated high-frequency current energy, and transmits the modulated high-frequency current energy to an input end of a receiver through a feeder.

The radiation arm may be a conductor having a specific shape and size, such as a wire antenna. A wire antenna is an antenna composed of one or more metal wires whose diameters are far less than a wavelength and whose lengths are comparable to the wavelength. The wire antenna may be used as a transmitting or receiving antenna. Main forms of wire antennas include dipole antennas, half-wave dipole antennas, monopole antennas, loop antennas, inverted F antennas (also referred to as IFA, Inverted F Antenna), planar inverted F antennas (also referred to as PIFA, Planar Inverted F Antenna), slot antennas, antenna arrays, and the like. For example, for the dipole antennas, each dipole antenna generally includes two radiating arms, and each branch is fed by a feeding portion from a feed end of the radiation branch. For example, for the slot antennas, a single radiation branch may be included, and two ends of the branch are grounded to form a slot or slit.

The radiation arm may also be a slot or slit formed in a conductor. For example, an antenna formed by slitting a conductor surface is also referred to as a slot antenna or a slot antenna. In some embodiments, a shape of the slit is a long strip. In some embodiments, a length of the slit is about half a wavelength. In some embodiments, the slit may be fed by a transmission line that is connected to one side or both sides of the slit in a spanning manner, or may be fed by a waveguide or resonant cavity. A radio frequency electromagnetic field is excited on the slit, and an electromagnetic wave is radiated to space.

Balun: a balanced-unbalanced converter that feeds two radiation arms of a same polarization of an antenna element and implements equal output amplitudes and a phase difference of 180°.

Co-directional/Reverse current distribution mentioned in embodiments of this application should be understood as that main currents on conductors on a same side are co-directional/reverse in direction. For example, when co-directionally distributed currents are excited on an annular conductor (for example, a current path is also annular), it should be understood that although main currents excited on conductors on two sides of the annular conductor (for example, on conductors around a slot, or on conductors on two sides of a slot) are in reverse directions, the main currents still meet a definition of the co-directionally distributed currents in this application.

Limitations such as collinearity, coaxiality, coplanarity, symmetry (for example, axisymmetricity or centrosymmetry), parallelism, perpendicularity, and sameness (for example, a same length and a same width) mentioned in embodiments of this application are all for the existing technology level, but are not absolutely strict definitions in a mathematical sense. A deviation less than a preset threshold (for example, 1 mm, 0.5 mm, or 0.1 mm) may exist in a line width direction between edges of two collinear radiation branches or two collinear antenna elements. A deviation less than a preset threshold (for example, 1 mm, 0.5 m, or 0.1 mm) may exist between edges of two coplanar radiation branches or two coplanar antenna elements in a direction perpendicular to a coplanar plane of the radiation branches or antenna elements. There may be a deviation of a preset angle (for example, ±5° or ±10°) between two antenna elements that are parallel or perpendicular to each other.

This application provides a base station system, an antenna apparatus 100, an antenna array 101, and an antenna element 10. The base station system, the antenna apparatus 100, the antenna array 101, and the antenna element 10 may be applied to fields such as radar, broadcast, and communication.

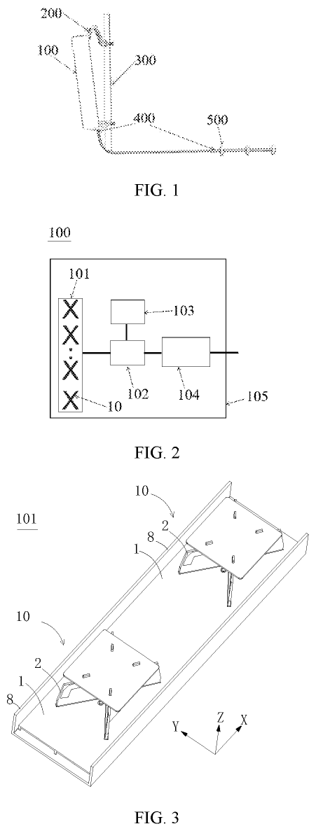

Refer to FIG. 1 which is a structural diagram of a base station system in some embodiments according to this application. As shown in FIG. 1, the base station system includes the antenna apparatus 100, an antenna adjustment support 200, a fastening pole 300, a connector sealing member 400, a ground apparatus 500, and the like. The base station system is an interface device for wireless communication and can exchange information with a communication terminal in a region in which the base station system is located.

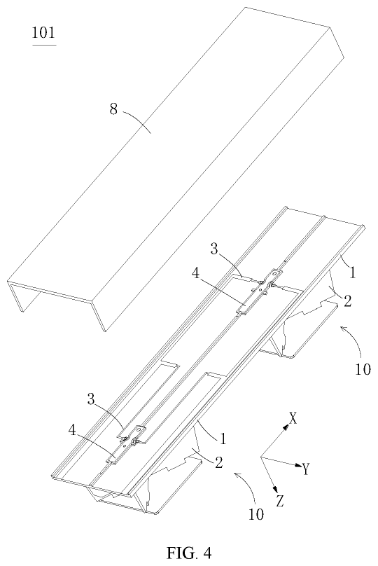

Refer to FIG. 2 to FIG. 4. FIG. 2 is a structural diagram of the antenna apparatus 100 in FIG. 1 in some embodiments. FIG. 3 is a structural diagram of an antenna array in an embodiment according to this application. FIG. 4 is a structural diagram of the antenna array in FIG. 3 from another perspective.

As shown in FIG. 2, the antenna apparatus 100 includes the antenna array 101, a phase shifter 102, a transmission network 103 or calibration network, a combiner 104 or waver, and a radome 105. Components such as the antenna array 101, the phase shifter 102, the transmission network 103 or calibration network, and the combiner 104 or waveguide are disposed in the radome 105. The radome 105 is a structural member that may protect internal components from being affected by an external environment. The radome has good electromagnetic wave penetration characteristics in electrical performance, and can withstand an external harsh environment in mechanical performance. In addition, refer to FIG. 3 and FIG. 4. The antenna array 101 includes a plurality of antenna elements 10, and receives or transmits radio frequency signals through components such as the phase shifter 102, the transmission network 103, and the combiner 104.

The following describes the antenna element 10 in detail with a specific embodiment. For ease of understanding, the following defines a length direction of the antenna element 10 as a first direction X, a width direction of the antenna element 10 as a second direction Y, and a height direction of the antenna element 10 as a third direction Z.

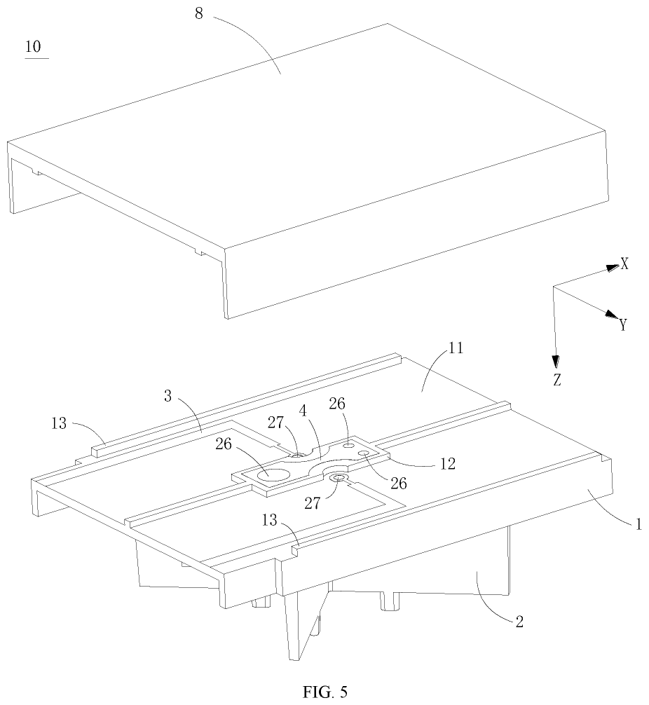

Refer to FIG. 5 which is an exploded diagram of an antenna element according to a first embodiment of this application. As shown in FIG. 5, the antenna element 10 includes an insulating substrate board 1. The insulating substrate board 1 may be made of ceramic, polycarbonate (PC), or modified polyester resin (PY). Certainly, the insulating substrate board may also be made of another material that may be used for energy radiation, or the like. This is not limited herein.

The antenna element 10 further includes a feed network 3. The feed network 3 is connected to the insulating substrate board 1. The feed network 3 can feed a signal to a radiation arm of the antenna element 10 based on a specific amplitude and phase, or transmit a received wireless signal to a signal processing unit of a base station based on a specific amplitude and phase. Generally, the feed network 3 includes controlled impedance transmission lines. The feed network 3 may include a coupling power splitter and a phase shifter, and may further include components such as a combiner and a filter in some cases.

It should be noted that, as shown in FIG. 3 and FIG. 4, for a same antenna array 101, insulating substrate boards 1 of a plurality of antenna elements 10 may be of an integrally formed structure. In addition, the plurality of antenna elements 10 may share one feed network 3, or the feed networks 3 of these antenna elements 10 may be connected in parallel or in series, to improve a degree of design freedom of the antenna element 10. This is not limited herein.

Still refer to FIG. 5. The antenna element 10 further includes a metal ground layer 4. The metal ground layer 4 is connected to the insulating substrate board 1. The metal ground layer 4 may be used for grounding of a component in the antenna apparatus 10. The metal ground layer 4 is made of a conductive material. In some embodiments, the conductive material may be any one of the following materials: copper, aluminum, stainless steel, brass and an alloy thereof, copper foil on an insulating substrate, aluminum foil on an insulating substrate, gold foil on an insulating substrate, silver-plated copper, silver-plated copper foil on an insulating substrate, silver foil and tin-plated copper on an insulating substrate, cloth impregnated with graphite powder, a graphite-coated substrate, a copper-plated substrate, a brass-plated substrate, and an aluminum-plated substrate. A person skilled in the art may understand that the metal ground layer 4 may also be made of another conductive material, which is not limited herein.

As shown in FIG. 5, the antenna element 10 further includes a reflector plate 8. The reflector plate 8 can focus radio frequency signals to a focal point of the radiation arm 5, thereby improving reception sensitivity of the radio frequency signals, and can block an interference wave outside the reflector plate 8. At least a portion of the reflector plate 8 is disposed on a side of the metal ground layer 4 facing away from the insulating substrate board 1. The reflector plate 8 is coupled to the metal ground layer 4 and the feed network 3.

It should be noted that, as shown in FIG. 3 and FIG. 4, for a same antenna array 101, reflector plates 8 of a plurality of antenna elements 10 may be of an integrally formed structure.

As shown in FIG. 5, the metal ground layer 4 is coupled to the feed network 3 and disposed on a same side of the insulating substrate board 1 as the feed network 3, so that dielectric loss between the feed network 3 and the reflector plate 8 can be reduced, and radiation performance of the antenna element 10 is improved. In addition, the metal ground layer 4 in this structure occupies a relatively small area on the insulating substrate board 1, which makes it possible that the feed network 3 and the metal ground layer 4 are disposed on the same side of the insulating substrate board 1. Moreover, this structure saves cabling space of the feed network 3.

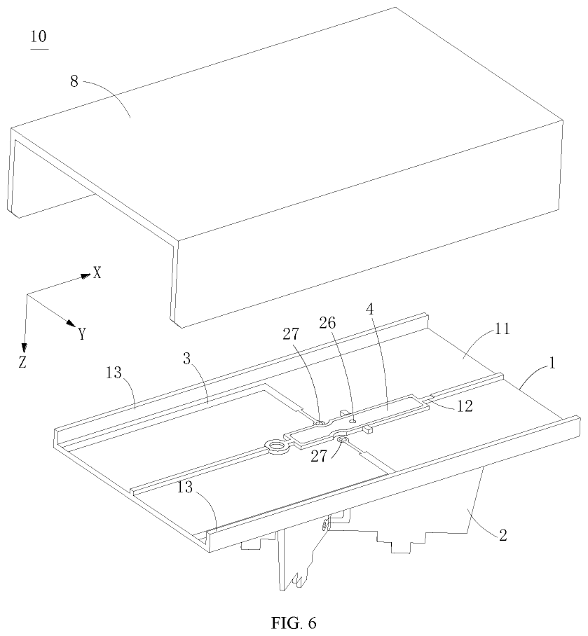

For example, refer to FIG. 6 which is an exploded diagram of an antenna element according to a second embodiment of this application. As shown in FIG. 5 and FIG. 6, each antenna element 10 may be provided with only one metal ground layer 4, and a ground balun of the antenna element 10 is electrically connected to the metal ground layer 4. In this way, structural complexity is further reduced, thereby facilitating manufacture and production, and reducing costs.

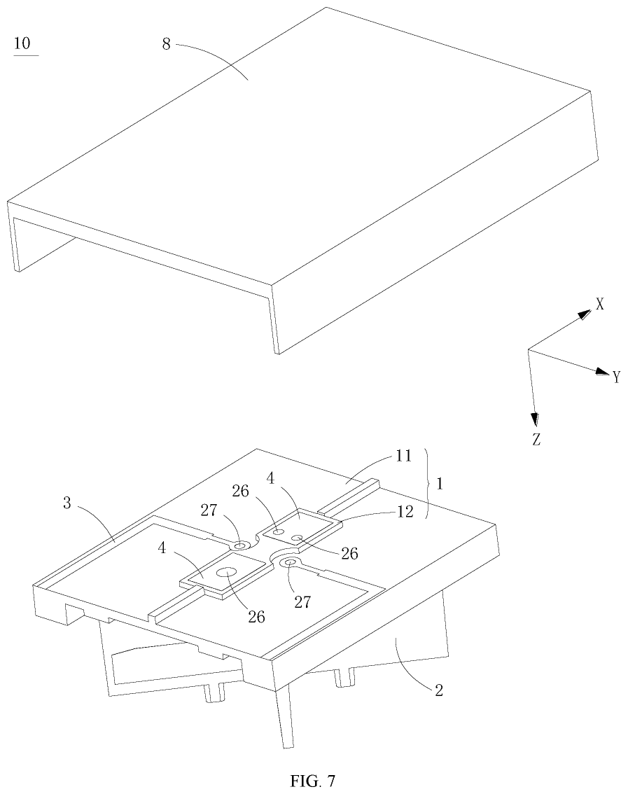

For example, refer to FIG. 7 which is an exploded diagram of an antenna element according to a third embodiment of this application. As shown in FIG. 7, each antenna element 10 may alternatively be provided with a plurality of metal ground layers 4, for example, two, three, or four. A specific quantity of the metal ground layers may be specified based on an actual requirement, and is not limited herein. Each metal ground layer 4 is correspondingly electrically connected to at least one of a plurality of ground baluns of the antenna element 10, so that it can not only ensure reliable grounding of the ground balun, but also further reduce space occupied by the metal ground layer 4 on the insulating substrate board 1, thereby facilitating flexible arrangement of the feed network 3 in the antenna element 10, and improving a degree of design freedom of the antenna element 10.

A shape of the metal ground layer 4 may be a circle, a rectangle, or another irregular shape, and may be specifically specified based on an actual requirement, to further improve a degree of design freedom of the antenna element 10. This is not limited herein.

As shown in FIG. 5, in a specific embodiment, the insulating substrate board 1 includes a board body 11 and a boss 12. Along the third direction Z, the boss 12 protrudes from a side of the board body 11 facing the reflector plate 8, the feed network 3 is disposed on the board body 11, and the metal ground layer 4 is disposed on the boss 12. Therefore, after the antenna element 10 is assembled, it can be ensured that the metal ground layer 4 disposed on the boss 12 is directly coupled to or coupled at an interval to the reflector plate 8. In addition, it can be ensured that the feed network 3 disposed on the board body 11 is kept a specific distance away from the reflector plate 8.

When the metal ground layer 4 is directly coupled to the reflector plate 8, that is, the metal ground layer 4 may be in direct contact connection with the reflector plate 8, the antenna element 10 of this structure has a simple structure and is easy to fabricate. For example, the insulating substrate board 1 may be connected to the reflector plate 8 by using a screw, adhesive, or the like, so that the metal ground layer 4 is fully attached to the reflector plate 8, to ensure radiation performance of the antenna element 10.

When the metal ground layer 4 is coupled at an interval to the reflector plate 8, it is unnecessary to use a screw or another structure for connecting the insulating substrate board 1 with the reflector plate 8, which further reduces structural complexity of the antenna element 10, reduces difficulty in coupling between the metal ground layer 4 and the reflector plate 8, and improves stability of the coupling between the metal ground layer 4 and the reflector plate 8.

Certainly, to further improve structural stability of the antenna element 10, the insulating substrate board 1 may alternatively be fastened to the reflector plate 8 through a screw.

For example, as shown in FIG. 5 and FIG. 6, the insulating substrate board 1 further includes a support portion 13 protruding from the board body 11 toward the reflector plate 8. The support portion 13 abuts against at least a part of the reflector plate 8. The metal ground layer 4 and the reflector plate 8 are spaced apart from each other. This structure is simple, costs are low, and it can be ensured that a spacing distance between the metal ground layer 4 and the reflector plate 8 is stable, so that stability of the coupling between the metal ground layer 4 and the reflector plate 8 is improved to ensure radiation performance of the antenna element 10.

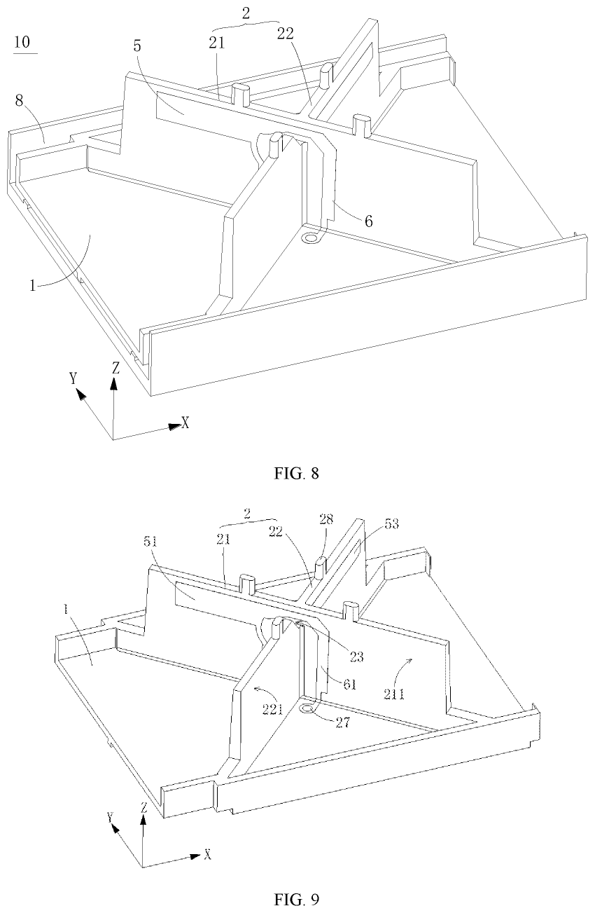

Refer to FIG. 8 which is a structural diagram of an antenna element according to a first embodiment of this application. As shown in FIG. 8, the antenna element 10 further includes an insulating substrate arm 2. The insulating substrate arm 2 is connected to the insulating substrate board 1 and disposed on a side of the insulating substrate board 1 facing away from the feed network 3 and the metal ground layer 4. The insulating substrate arm 2 may be integrally formed with the insulating substrate board 1, so that production processes of the antenna element 10 can be reduced, which facilitates automatic production of the antenna element 10, improves production efficiency, and reduces costs.

As shown in FIG. 8, the antenna element 10 further includes a radiation arm 5. As a main radiator of the antenna element 10, the radiation arm 5 may effectively radiate or receive a radio frequency signal. In addition, refer to FIG. 3. The radiation arm 5 is disposed on the insulating substrate arm 2. To be specific, in this embodiment of this application, along the third direction Z, the feed network 3 and the radiation arm 5 disposed on the insulating substrate arm 2 are respectively disposed on two opposite sides of the insulating substrate board 1, so that coupling between the feed network 3 and the radiation arm 5 can be reduced, which effectively improves radiation performance and isolation of the antenna element 10.

As shown in FIG. 8, the antenna element 10 further includes a feed balun 6. The feed balun 6 is disposed on the insulating substrate arm 2. One end of the feed balun 6 is electrically connected to the feed network 3, and the other end is electrically connected to the radiation arm 5 to feed the radiation arm 5.

The radiation arm 5, the feed balun 6, the feed network 3, and the metal ground layer 4 may be formed on the insulating substrate arm 2 and/or the insulating substrate board 1 according to, for example, a plating process or an LDS process, thereby further facilitating automatic production of the antenna element 10, decreasing a weight of the antenna element 10, and reducing costs.

Further, refer to FIG. 9 to FIG. 12 which are structural diagrams of a partial structure of the antenna element in FIG. 8 from a first perspective, a second perspective, a third perspective, and a fourth perspective respectively.

As shown in FIG. 9 to FIG. 12, the insulating substrate arm 2 includes a first plate 21 and a second plate 22 intersecting with each other. The first plate 21 has a first surface 211 and a second surface 212 that are disposed opposite to each other. The second plate 22 has a third surface 221 and a fourth surface 222 that are disposed opposite to each other.

An included angle between the first plate 21 and the second plate 22 may range from 60° to 120°, to meet design requirements of different antenna elements 10.

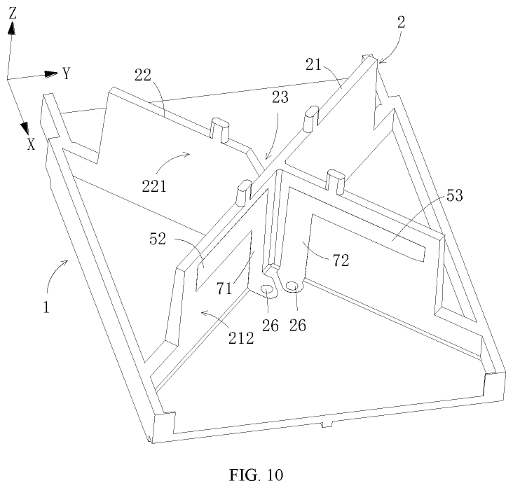

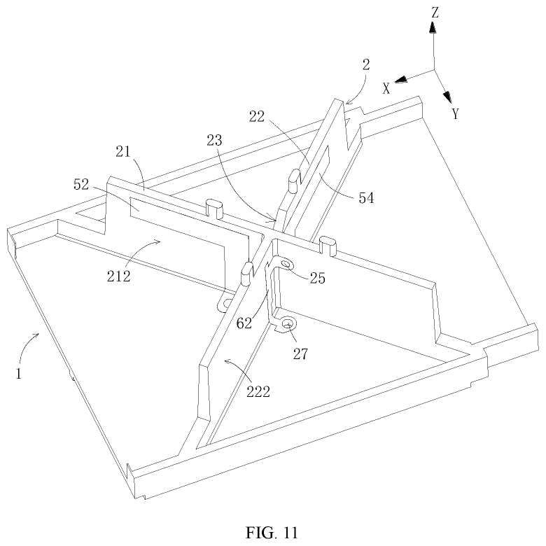

In a specific embodiment, the radiation arm 5 includes a first radiation arm 51, a second radiation arm 52, a third radiation arm 53, and a fourth radiation arm 54. As shown in FIG. 9 and FIG. 10, the first radiation arm 51 is disposed on the first surface 211. The second radiation arm 52 is disposed on the second surface 212. The first radiation arm 51 and the second radiation arm 52 are respectively disposed on two sides of the second plate 22. The feed balun 6 is configured to feed the first radiation arm 51 and the second radiation arm 52 to generate first polarization. As shown in FIG. 10 and FIG. 11, the third radiation arm 53 is disposed on the third surface 221. The fourth radiation arm 54 is disposed on the fourth surface 222. The third radiation arm 53 and the fourth radiation arm 54 are respectively disposed on two sides of the first plate 21. The feed balun 6 is configured to feed the third radiation arm 53 and the fourth radiation arm 54 to generate second polarization.

In this structure, two radiation arms of a same polarization are disposed on two opposite surfaces of a same plate in a staggered manner, so that the first radiation arm 51, the second radiation arm 52, the third radiation arm 53, and the fourth radiation arm 54 are disposed on the first plate 21 and the second plate 22 more properly, which not only ensures radiation performance of the first radiation arm 51, the second radiation arm 52, the third radiation arm 53, and the fourth radiation arm 54, but also reduces space occupied by the first radiation arm 51, the second radiation arm 52, the third radiation arm 53, and the fourth radiation arm 54 on the first plate 21 and the second plate 22. Therefore, convenience is brought for disposing the feed balun 6 on the first plate 21 and the second plate 22 flexibly, which not only improves a degree of design freedom of the antenna element 10, but also can reduce a size and disposing difficulty of the insulating substrate arm 2, thereby facilitating miniaturization design of the antenna element 10.

Further, as shown in FIG. 9 and FIG. 11, the feed balun 6 includes a first feed balun 61 and a second feed balun 62. In addition, refer to FIG. 5, the insulating substrate board 1 may be provided with a fourth plated through hole 27, so that the first feed balun 61 and the second feed balun 62 may be electrically connected to the feed network 3 via the fourth plated through hole 27. This structure is simple and easy to implement, thereby further reducing fabrication costs.

As shown in FIG. 9, the first feed balun 61 is disposed on the first surface 211. The first feed balun 61 is electrically connected to the first radiation arm 51 disposed on the same surface. In addition, refer to FIG. 10. The first feed balun 61 is coupled to the second radiation arm 52, so that the first feed balun 61 can feed both the first radiation arm 51 and the second radiation arm 52 to generate the first polarization.

As shown in FIG. 11, the second feed balun 62 is disposed on the fourth surface 222. The second feed balun 62 is electrically connected to the fourth radiation arm 54 disposed on the same surface. In addition, refer to FIG. 10, the second feed balun 62 is coupled to the third radiation arm 53, so that the second feed balun 62 can feed both the third radiation arm 53 and the fourth radiation arm 54 to generate second polarization.

The structure is simple, and space occupied by the first feed balun 61 and the second feed balun 62 can be reduced, so that structural complexity of the antenna element 10 is further reduced, thereby facilitating miniaturization design of the antenna element 10.

Further, the feed balun 6 may be directly connected to the radiation arm 5 disposed on a same surface as the feed balun, to ensure that a connection between the feed balun 6 and the radiation arm 5 is stable. Certainly, the feed balun 6 may alternatively be connected to the radiation arm 5 disposed on the same surface as the feed balun through a plated through hole, so that design difficulty of the insulating substrate arm 2 can be further reduced, thereby facilitating flexible connection of the feed balun 6 to the radiation arm 5, and improving a degree of design freedom of the antenna element 10. A specific manner of connecting the feed balun 6 to the radiation arm 5 disposed on the same surface as the feed balun may be specified based on an actual requirement, and is not limited herein.

For example, both the first feed balun 61 and the second feed balun 62 may be directly connected to the radiation arm 5 disposed on a same surface as the feed baluns. As shown in FIG. 9, the second plate 22 may be provided with a first through hole 23. The first through hole 23 is provided on a side of the second plate 22 close to the first surface 211, so that at least a portion of the first feed balun 61 may pass through the first through hole 23 and be electrically connected to the first radiation arm 51 disposed on a same surface as the first feed balun 61. In addition, the first plate 21 may be provided with a second through hole (not shown in the figure). The second through hole is provided on a side of the first plate 21 close to the fourth surface 222, so that the second feed balun 62 may be electrically connected, via the second through hole, to the fourth radiation arm 54 disposed on a same surface as the second feed balun.

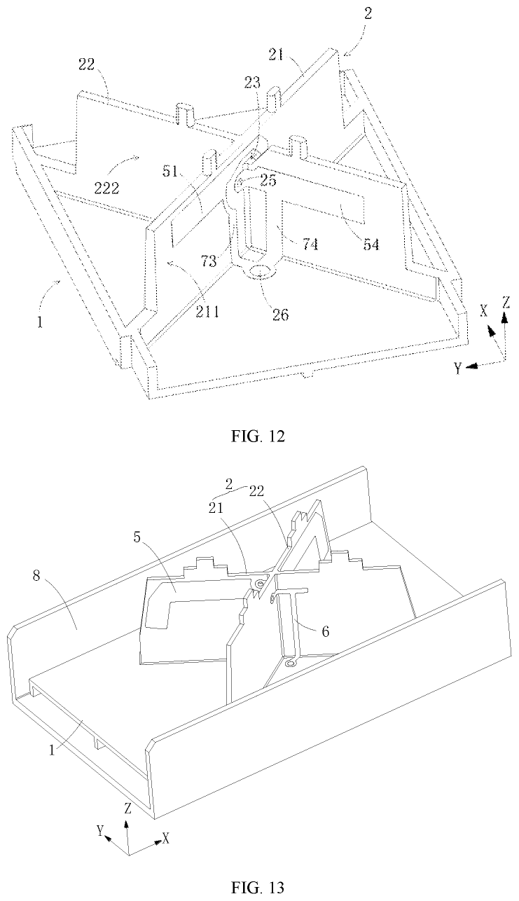

For example, the first feed balun 61 or the second feed balun 62 is directly connected to a radiation arm on a same surface as the first feed balun 61 or the second feed balun 62, and the second feed balun 62 or the first feed balun 61 is connected, through a plated through hole, to a radiation arm on a same surface as the second feed balun 62 or the first feed balun 61. In a specific embodiment shown in FIG. 9, the second plate 22 may be provided with a first through hole 23. The first through hole 23 is provided on a side of the second plate 22 close to the first surface 211, so that at least a portion of the first feed balun 61 may pass through the first through hole 23 and be electrically connected to the first radiation arm disposed on a same surface as the first feed balun 61. In addition, refer to FIG. 11 and FIG. 12. The first plate 21 is provided with a second plated through hole 25. The second plated through hole 25 is provided on a side of the first plate 21 close to the fourth surface 222. At least a portion of the second feed balun 62 extends to the first plate 21 and is electrically connected, through the second plated through hole 25, to the fourth radiation arm 54 disposed on a same surface as the second feed balun.

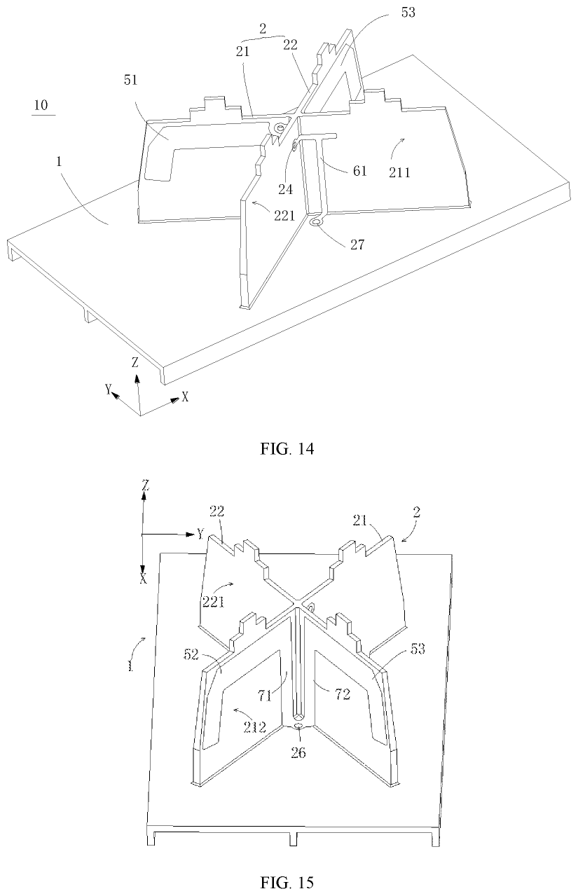

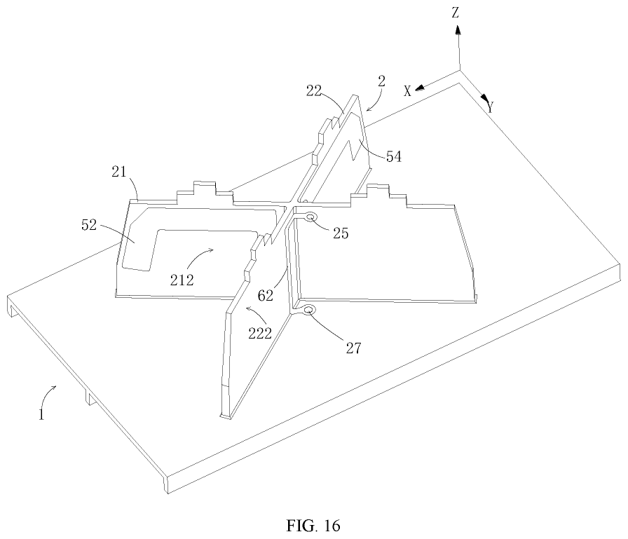

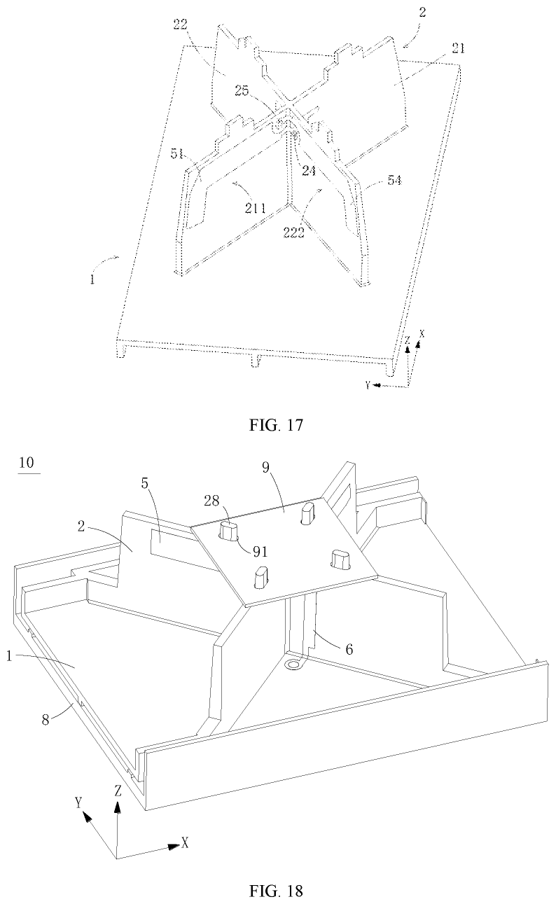

For example, both the first feed balun 61 and the second feed balun 62 may alternatively be connected, through plated through holes, to the radiation arm 5 disposed on a same surface as the feed baluns. Refer to FIG. 13 to FIG. 17. FIG. 13 is a structural diagram of an antenna element according to a second embodiment of this application. FIG. 14 to FIG. 17 are structural diagrams of a partial structure of the antenna element in FIG. 13 from a first perspective, a second perspective, a third perspective, and a fourth perspective respectively. As shown in FIG. 14 and FIG. 17, the second plate 22 may be provided with a first plated through hole 24. The first plated through hole 24 is provided on a side of the second plate 22 close to the first surface 211. At least a portion of the first feed balun 61 extends to the second plate 22 and is electrically connected, via the first plated through hole 24, to the first radiation arm 51 disposed on a same surface as the first feed balun 61. Alternatively, as shown in FIG. 16 and FIG. 17, the first plate 21 is provided with a second plated through hole 25. The second plated through hole 25 is provided on a side of the first plate 21 close to the fourth surface 222. At least a portion of the second feed balun 62 extends to the first plate 21 and is electrically connected, via the second plated through hole 25, to the fourth radiation arm 54 disposed on a same surface as the second feed balun.

Further, as shown in FIG. 10, the antenna element 10 further includes a first ground balun 71 and a second ground balun 72. In addition, refer to FIG. 9 and FIG. 10. The first ground balun 71 is disposed on the second surface 212 and correspondingly coupled to the first feed balun 61 disposed on the first surface 211. One end of the first ground balun 71 is electrically connected to the second radiation arm 52, and the other end is electrically connected to the metal ground layer 4. The first feed balun 61 is coupled to the first ground balun 71, so that the first feed balun 61 can feed a current to the second radiation arm 52 through the first ground balun 71, thereby meeting a feeding requirement of the second radiation arm 52. In addition, due to the first ground balun 71, it can be ensured that currents on the first radiation arm 51 and the second radiation arm 52 of the same polarization flow in consistent directions, thereby forming a dipole. This meets a design requirement of the antenna element 10.

In addition, refer to FIG. 10 and FIG. 11. The second ground balun 72 is disposed on the third surface 221 and correspondingly coupled to the second feed balun 62 disposed on the fourth surface 222. One end of the second ground balun 72 is electrically connected to the third radiation arm 53, and the other end is electrically connected to the metal ground layer 4. The second feed balun 62 is coupled to the second ground balun 72, so that the second feed balun 62 can feed a current to the third radiation arm 53 through the second ground balun 72, thereby meeting a feeding requirement of the third radiation arm 53. In addition, due to the second ground balun 72, it can be ensured that currents on the third radiation arm 53 and the fourth radiation arm 54 of the same polarization flow in consistent directions, thereby forming a dipole. This meets a design requirement of the antenna element 10.

Further, as shown in FIG. 10, the insulating substrate board 1 may be provided with a third plated through hole 26. In addition, refer to FIG. 5. The first ground balun 71 and the second ground balun 72 may be connected, via the third plated through hole 26, to the metal ground layer 4 disposed on the other side of the insulating substrate board 1. This structure is simple and easy to implement, thereby further reducing fabrication costs.

For example, in specific embodiments shown in FIG. 5 and FIG. 10, the first ground balun 71 and the second ground balun 72 may be connected, respectively through third plated through holes 26 corresponding thereto, to the metal ground layer 4 on the other side of the insulating substrate board 1. For example, in specific embodiments shown in FIG. 6 and FIG. 15, the first ground balun 71 and the second ground balun 72 may alternatively be connected, through one same third plated through hole 26, to the metal ground layer 4 disposed on the other side of the insulating substrate board 1, so that structural complexity is further reduced, thereby reducing fabrication costs, and improving a degree of design freedom of the antenna element 10.

In a specific embodiment, as shown in FIG. 12, the antenna element 10 further includes a third ground balun 73 and a fourth ground balun 74. The third ground balun 73 is disposed on the first surface 211. One end of the third ground balun 73 is electrically connected to the first radiation arm 51, and the other end is electrically connected to the metal ground layer 4. The fourth ground balun 74 is disposed on the fourth surface 222. One end of the fourth ground balun 74 is electrically connected to the fourth radiation arm 54, and the other end is electrically connected to the metal ground layer 4.

In this embodiment, as shown in FIG. 9 to FIG. 12, when the first feed balun 61 feeds the first radiation arm 51, the third ground balun 73 may be equivalent to a short circuit of a ¼ wavelength, so that balanced feeding of the first radiation arm 51 can be achieved, thereby ensuring that current amplitudes and phases on the first radiation arm 51 and the second radiation arm 52 of the same polarization are centrosymmetric, and improving radiation performance of the antenna element 10. When the second feed balun 62 feeds the fourth radiation arm 54, the fourth ground balun 74 may be equivalent to a short circuit of a ¼ wavelength, so that balanced feeding of the fourth radiation arm 54 can be achieved, thereby ensuring that current amplitudes and phases on the third radiation arm 53 and the fourth radiation arm 54 of the same polarization are centrosymmetric, and improving radiation performance of the antenna element 10.

Further, as shown in FIG. 12, the insulating substrate board 1 may be provided with a third plated through hole 26. In addition, refer to FIG. 5. The third ground balun 73 and the fourth ground balun 74 may be connected, via the third plated through hole 26, to the metal ground layer 4 disposed on the other side of the insulating substrate board 1. This structure is simple and easy to implement, thereby further reducing fabrication costs.

For example, in specific embodiments shown in FIG. 5 and FIG. 10, the third ground balun 73 and the fourth ground balun 74 may be connected, through one same third plated through hole 26, to the metal ground layer 4 disposed on the other side of the insulating substrate board 1, so that structural complexity is further reduced, thereby reducing fabrication costs. Certainly, the third ground balun 73 and the fourth ground balun 74 may alternatively be connected, respectively through third plated through holes 26 corresponding thereto, to the metal ground layer 4 disposed on the other side of the insulating substrate board 1, so that a degree of design freedom of the antenna element 10 is further improved.

It should be noted that a quantity and locations of the third plated through holes 26 may be flexibly adjusted based on specific locations of the first ground balun 71, the second ground balun 72, the third ground balun 73, and the fourth ground balun 74. This is not limited herein.

The first ground balun 71, the second ground balun 72, the third ground balun 73, and the fourth ground balun 74 may be formed on the insulating substrate arm 2 and/or the insulating substrate board 1 according to, for example, a plating process or an LDS process, thereby further facilitating automatic production of the antenna element 10, decreasing a weight of the antenna element 10, and reducing costs.

Further, as shown in FIG. 12, in a specific embodiment, the first radiation arm 51 is disposed on a side of the first surface 211 close to the fourth surface 222. As shown in FIG. 10, the second radiation arm 52 is disposed on a side of the second surface 212 close to the third surface 221. The third radiation arm 53 is disposed on a side of the third surface 221 close to the second surface 212. As shown in FIG. 12, the fourth radiation arm 54 is disposed on a side of the fourth surface 222 close to the first surface 211.

In this embodiment, as shown in FIG. 12, the first radiation arm 51 and the fourth radiation arm 54 may be disposed on two adjacent surfaces, so that a third ground balun 73 and a fourth ground balun 74 may be disposed relatively close to each other. Therefore, the third ground balun 73 and the fourth ground balun 74 may be connected, through one same third plated through hole 26, to a metal ground layer 4 disposed on the other side of the insulating substrate board 1. In addition, as shown in FIG. 15, the second radiation arm 52 and the third radiation arm 53 may be disposed on two adjacent surfaces, so that a first ground balun 71 and a second ground balun 72 may be disposed relatively close to each other. Therefore, the first ground balun 71 and the second ground balun 72 may alternatively be connected, through one same third plated through hole 26, to a metal ground layer 4 disposed on the other side of the insulating substrate board 1, thereby further reducing structural complexity of the antenna element 10, improving production efficiency, and reducing fabrication costs, which facilitates miniaturization and lightweight design of the antenna element 10.

In some specific embodiments, as shown in FIG. 17, alternatively, the antenna element 10 may be provided without the third ground balun 73 or the fourth ground balun 74, so that structural complexity of the antenna element 10 is further reduced, thereby improving production efficiency, and reducing fabrication costs, which facilitates miniaturization and lightweight design of the antenna element 10.

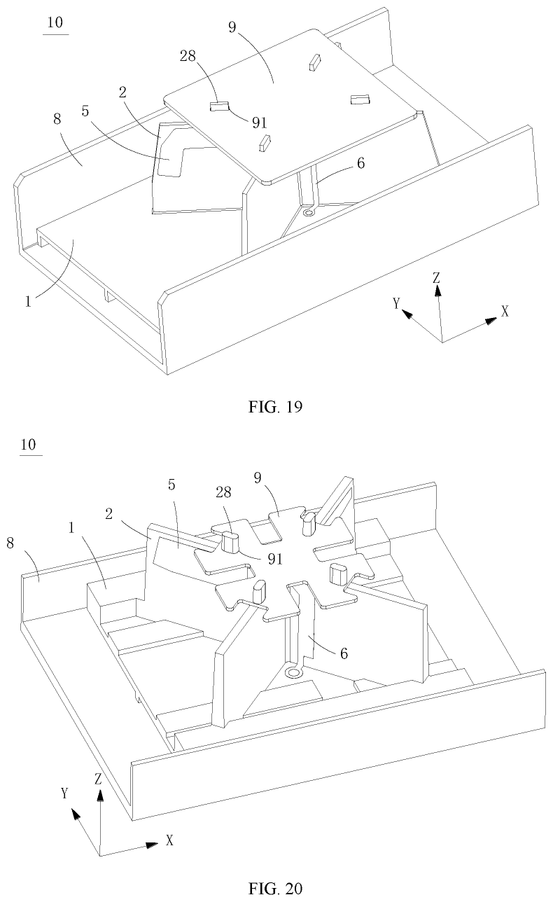

Further, refer to FIG. 18 to FIG. 20. FIG. 18 is a diagram of a connection between a guiding layer and an insulating substrate arm according to a first embodiment of this application. FIG. 19 is a diagram of a connection between a guiding layer and an insulating substrate arm according to a second embodiment of this application. FIG. 20 is a diagram of a connection between a guiding layer and an insulating substrate arm according to a third embodiment of this application.

As shown in FIG. 18 to FIG. 20, along the third direction Z, the antenna element 10 may further include a guiding layer 9 made of a metal material and disposed at a top end of the insulating substrate arm 2, to further adjust isolation of the antenna element 10, and improve radiation performance of the antenna element 10.

As shown in FIG. 18 to FIG. 20, in a specific embodiment, along the third direction Z, a protrusion 28 may protrude from the top end of the insulating substrate arm 2. The guiding layer 9 may be provided with a recess 91 at a position corresponding to the protrusion 28. The protrusion 28 is correspondingly connected to the recess 91, so as to limit displacement of the guiding layer 9 at the top end of the insulating substrate arm 2. Therefore, structural stability of the antenna element 10 is improved, and a radiation effect of the antenna element 10 is ensured.

Certainly, the guiding layer 9 may alternatively be fixed at the top end of the insulating substrate arm 2 via bonding, screw connection, or in another manner, which is not limited herein.

For example, as shown in FIG. 18 and FIG. 19, the guiding layer 9 may be a rectangular sheet structure. A size of the guiding layer may be specified based on an actual requirement of the antenna element 10, and is not limited herein.

For example, as shown in FIG. 20, the guiding layer 9 may alternatively be an irregular-shaped sheet structure with a plurality of notches, thereby further improving a degree of design freedom of the antenna element 10, and meeting different arrangement requirements of the antenna element 10.

Certainly, the guiding layer 9 may alternatively be another metal layer disposed at the top end of the insulating substrate arm 2, which is not limited herein.

For same or similar parts of embodiments of this specification, refer to each other. Especially, apparatus and terminal embodiments are basically similar to a method embodiment, and therefore are described briefly. For related parts, refer to partial descriptions in the method embodiment.

The foregoing descriptions are merely specific implementations of embodiments of this application, but are not intended to limit the protection scope of embodiments of this application. Any variation or replacement within the technical scope disclosed in embodiments of this application shall fall within the protection scope of embodiments of this application. Therefore, the protection scope of embodiments of this application shall be subject to the protection scope of the claims.

1. An antenna element, comprising:
an insulating substrate board;
a feed network, connected to the insulating substrate board;
a metal ground layer, connected to the insulating substrate board and disposed on a same side of the insulating substrate board as the feed network;
a reflector plate, wherein at least a portion of the reflector plate is disposed on a side of the metal ground layer facing away from the insulating substrate board, and the reflector plate is coupled to the metal ground layer and the feed network;
an insulating substrate arm, connected to the insulating substrate board and disposed on a side of the insulating substrate board facing away from the feed network and the metal ground layer;
a radiation arm, disposed on the insulating substrate arm; and
a feed balun, disposed on the insulating substrate arm, wherein one end of the feed balun is electrically connected to the feed network, and the other end is electrically connected to the radiation arm to feed the radiation arm.

2. The antenna element according to claim 1, wherein the insulating substrate board comprises a board body and a boss, and the boss protrudes from the board body;
the feed network is disposed on the board body; and
the metal ground layer is disposed on the boss.

3. The antenna element according to claim 1, wherein the metal ground layer is directly coupled to the reflector plate.

4. The antenna element according to claim 2, wherein the insulating substrate board further comprises a support portion protruding from the board body toward the reflector plate, and the support portion abuts against at least a part of the reflector plate; and
the metal ground layer and the reflector plate are spaced apart from each other.

5. The antenna element according to claim 1, wherein the insulating substrate arm comprises a first plate and a second plate intersecting with each other, the first plate comprises a first surface and a second surface that are disposed opposite to each other, and the second plate comprises a third surface and a fourth surface that are disposed opposite to each other;
the radiation arm comprises a first radiation arm, a second radiation arm, a third radiation arm, and a fourth radiation arm;
the first radiation arm is disposed on the first surface, the second radiation arm is disposed on the second surface, the first radiation arm and the second radiation arm are respectively disposed on two sides of the second plate, and the feed balun is configured to feed the first radiation arm and the second radiation arm to generate first polarization; and
the third radiation arm is disposed on the third surface, the fourth radiation arm is disposed on the fourth surface, the third radiation arm and the fourth radiation arm are respectively disposed on two sides of the first plate, and the feed balun is configured to feed the third radiation arm and the fourth radiation arm to generate second polarization.

6. The antenna element according to claim 5, wherein the first radiation arm is disposed on a side of the first surface close to the fourth surface, and the second radiation arm is disposed on a side of the second surface close to the third surface; and
the third radiation arm is disposed on a side of the third surface close to the second surface, and the fourth radiation arm is disposed on a side of the fourth surface close to the first surface.

7. The antenna element according to claim 5, wherein the feed balun comprises a first feed balun and a second feed balun;
the first feed balun is disposed on the first surface, electrically connected to the first radiation arm, and coupled to the second radiation arm; and
the second feed balun is disposed on the fourth surface, electrically connected to the fourth radiation arm, and coupled to the third radiation arm.

8. The antenna element according to claim 7, wherein the second plate is provided with a first through hole, the first through hole is provided on a side of the second plate close to the first surface, and at least a portion of the first feed balun passes through the first through hole and is electrically connected to the first radiation arm; and/or
the first plate is provided with a second through hole, the second through hole is provided on a side of the first plate close to the fourth surface, and the second feed balun is electrically connected to the fourth radiation arm through the second through hole.

9. The antenna element according to claim 7, wherein the second plate is provided with a first plated through hole, the first plated through hole is provided on a side of the second plate close to the first surface, and at least a portion of the first feed balun extends to the second plate and is electrically connected to the first radiation arm through the first plated through hole; and/or
the first plate is provided with a second plated through hole, the second plated through hole is provided on a side of the first plate close to the fourth surface, and at least a portion of the second feed balun extends to the first plate and is electrically connected to the fourth radiation arm through the second plated through hole.

10. The antenna element according to claim 7, wherein the antenna element further comprises a first ground balun and a second ground balun;
the first ground balun is disposed on the second surface and correspondingly coupled to the first feed balun, one end of the first ground balun is electrically connected to the second radiation arm, and the other end is electrically connected to the metal ground layer; and
the second ground balun is disposed on the third surface and correspondingly coupled to the second feed balun, one end of the second ground balun is electrically connected to the third radiation arm, and the other end is electrically connected to the metal ground layer.

11. The antenna element according to claim 1, wherein the antenna element further comprises a third ground balun and a fourth ground balun;
the third ground balun is disposed on the first surface, one end of the third ground balun is electrically connected to the first radiation arm, and the other end is electrically connected to the metal ground layer; and
the fourth ground balun is disposed on the fourth surface, one end of the fourth ground balun is electrically connected to the fourth radiation arm, and the other end is electrically connected to the metal ground layer.

12. The antenna element according to claim 11, wherein a plurality of metal ground layers are provided, and each metal ground layer is correspondingly electrically connected to at least one of the first ground balun, the second ground balun, the third ground balun, or the fourth ground balun.

13. The antenna element according to claim 11, wherein one metal ground layer is provided, and the first ground balun, the second ground balun, the third ground balun, and the fourth ground balun are electrically connected to the metal ground layer.

14. The antenna element according to claim 11, wherein the insulating substrate board is provided with a third plated through hole, and at least one of the first ground balun, the second ground balun, the third ground balun, or the fourth ground balun is electrically connected to the metal ground layer through the third plated through hole.

15. The antenna element according to claim 1, wherein the insulating substrate board is provided with a fourth plated through hole, and the feed balun is electrically connected to the feed network through the fourth plated through hole.

16. An antenna apparatus, wherein the antenna apparatus comprises an antenna element comprising:
an insulating substrate board;
a feed network, connected to the insulating substrate board;
a metal ground layer, connected to the insulating substrate board and disposed on a same side of the insulating substrate board as the feed network;
a reflector plate, wherein at least a portion of the reflector plate is disposed on a side of the metal ground layer facing away from the insulating substrate board, and the reflector plate is coupled to the metal ground layer and the feed network;
an insulating substrate arm, connected to the insulating substrate board and disposed on a side of the insulating substrate board facing away from the feed network and the metal ground layer;
a radiation arm, disposed on the insulating substrate arm; and
a feed balun, disposed on the insulating substrate arm, wherein one end of the feed balun is electrically connected to the feed network, and the other end is electrically connected to the radiation arm to feed the radiation arm.

17. The antenna apparatus according to claim 16, wherein the insulating substrate board comprises a board body and a boss, and the boss protrudes from the board body;
the feed network is disposed on the board body; and
the metal ground layer is disposed on the boss.

18. The antenna apparatus according to claim 16, wherein the metal ground layer is directly coupled to the reflector plate.

19. The antenna apparatus according to claim 17, wherein the insulating substrate board further comprises a support portion protruding from the board body toward the reflector plate, and the support portion abuts against at least a part of the reflector plate; and
the metal ground layer and the reflector plate are spaced apart from each other.

20. The antenna apparatus according to claim 16, wherein the insulating substrate arm comprises a first plate and a second plate intersecting with each other, the first plate comprises a first surface and a second surface that are disposed opposite to each other, and the second plate comprises a third surface and a fourth surface that are disposed opposite to each other;
the radiation arm comprises a first radiation arm, a second radiation arm, a third radiation arm, and a fourth radiation arm;
the first radiation arm is disposed on the first surface, the second radiation arm is disposed on the second surface, the first radiation arm and the second radiation arm are respectively disposed on two sides of the second plate, and the feed balun is configured to feed the first radiation arm and the second radiation arm to generate first polarization; and
the third radiation arm is disposed on the third surface, the fourth radiation arm is disposed on the fourth surface, the third radiation arm and the fourth radiation arm are respectively disposed on two sides of the first plate, and the feed balun is configured to feed the third radiation arm and the fourth radiation arm to generate second polarization.
